(19) United States
(12) Patent Application Publication
(10) Pub. No.: US 2022/0171770 A1
(43) Pub. Date: Jun. 2, 2022

(54) METHODS, MEDIA, AND SYSTEMS FOR MULTI-PARTY SEARCHES

(71) Applicant: Capital One Services, LLC, McLean, VA (US)

(72) Inventors: Jacob CREECH, Mckinney, TX (US); David GILLAM, The Colony, TX (US); Alex BAIRD, Carrollton, TX (US); Eduardo Alberto Gonzalez GARCIA, Lewisville, TX (US)

(73) Assignee: Capital One Services, LLC, McLean, VA (US)

(21) Appl. No.: 17/106,470

(22) Filed: Nov. 30, 2020

(51) Int. Cl. G06F 16/242; G06F 16/2455; G06F 16/22; G06F 16/2457; G06F 16/953; G06Q 30/02; G06Q 40/00; G06Q 40/02; G06Q 10/08; G06Q 30/00

(52) U.S. Cl. CPC G06F 16/2425; G06F 16/24564; G06F 16/2246; G06F 16/24578; G06F 16/953; G06Q 30/018; G06Q 40/10; G06Q 40/12; G06Q 40/025; G06Q 10/087; G06Q 30/0278

(57) ABSTRACT

Methods, media and systems for providing search results are disclosed. A data set is received at a computing device of a first party from a client device associated with a second party. The data set is constructed based on a set of rules established by the second party, where one portion is inaccessible to the first party, while another portion is accessible to the first party. The accessible portion includes at least an information tag or a threshold value related to corresponding fields in the records. A set of records to be queried is eliminated based on at least one information tag or at least one threshold value. The remainder is searched at the computing device of the first party resulting in a set of search results. At least a portion of the search results are transmitted from the computing device of the first party to the second party.

### BACKGROUND

Certain searches present dimensions of complication, particularly when multiple parties contribute data or inputs to return results of the query. The number or type of variables that factor into executing the search may not all reside with a single party. The computational processes and resources may also differ across these parties, which may in turn affect a user's experience when performing the search. These issues are less concerning when record sets are manageable in size, but the effects can become noticeable and a limiting factor when searching larger databases of records.

For instance, vehicle listing services aggregate millions of available new and used automobiles. However, dealerships or financial lenders may use such a vehicle listing service to provide search results as an extension of, or a substitute for, their own inventory. This multi-party relationship is not confined to automobiles, as a selling agent, a buying agent, and/or a lender may similarly each employ a real estate listing service as part of the search process for a home or property. The listing services may take steps to return search results quickly and satisfy expectations regarding the user experience, but intervening parties may not be able to replicate the same level of speed and service.

Lending can be a complicating factor in delivering relevant search results based on the variability in credit applications, which may also slow down search results. To overcome this aspect, lenders may form close partnerships to provide suitable search results as part of their financing and purchasing processes. In these arrangements, lenders may be in position to share information regarding credit decisions and calculations more freely with the listing service in a back and forth manner, thereby reducing the technical challenges noted above. At other times, however, these entities may be less inclined to cooperate or may even be directly in competition. Regardless of the level of cooperation, security of the lenders' information can also factor into the comfort level of data sharing between entities. Under these conditions, searches can be ineffective or take too long to adequately meet user expectations.

Accordingly, systems, methods and media are needed that enable multi-party collaboration in providing search results while allowing the parties to shield certain data. Moreover, searches conducted by multiple parties with adequate data safeguards in place should retain adequate performance characteristics so as not to negatively alter the end-user experience.

### BRIEF DESCRIPTION OF THE DRAWINGS

Descriptions are given with reference to the figures included herein. When possible and for clarity, reference numbers are kept consistent from figure to figure. Some of the figures are simplified diagrams, which are not to be interpreted as drawn to scale or spatially limiting for the described embodiments. Where appropriate, the particular perspective or orientation of a figure will be given to increase understanding of the depicted features.

FIG. 1 is a block diagram of a system for performing a search, according to embodiments of the present disclosure;

FIG. 2 is a flowchart representing a method of providing search results, according to embodiments of the present disclosure;

FIG. 3 is simplified diagram of a data structure for carrying out a search, according to embodiments of the present disclosure;

FIG. 4 is a flowchart representing a method of receiving search results, according to embodiments of the present disclosure; and

FIG. 5 is a computer system, according to an embodiment of the present disclosure.

### DETAILED DESCRIPTION

Systems, media, and methods allowing multiple parties to deliver search results without the parties sharing all data relevant to the searches are described in detail below. A first party can maintain a large database of records to be searched (such as records for automobiles or real estate properties). A second party can transmit rules-based searches to be performed in coordination with the first party's database. The first party can use an accessible portion of a rules set in order to eliminate records to be searched, enabling technological performance expectations to be met (e.g., response time of the search). The second party can present the search results to end users without sharing certain sensitive or proprietary information to the first party, such as internal credit scoring methodologies.

The accessible portion of a rules set shared by the second party can include information tags or field values to eliminate certain records to be searched. This can reduce the time needed to perform the search and avoid degradation of performance characteristics of the search. The shared information tags or values allow the second party to retain the integrity of sensitive rule sets and internal calculations, while simultaneously improving performance characteristics.

While shown in the singular and with simplified terms in the figures and below, one of skill in the relevant art will recognize that implementation of the described embodiments can take many forms. Thus, a single device depicted in the figures or described below may represent several, dozens or hundreds of the devices disclosed. The particular arrangement is likewise not a limiting factor with respect to the scope of the present application. Steps may be performed in a different order, while communications may be carried out directly or indirectly with various devices performing intermediary functions between those described devices.

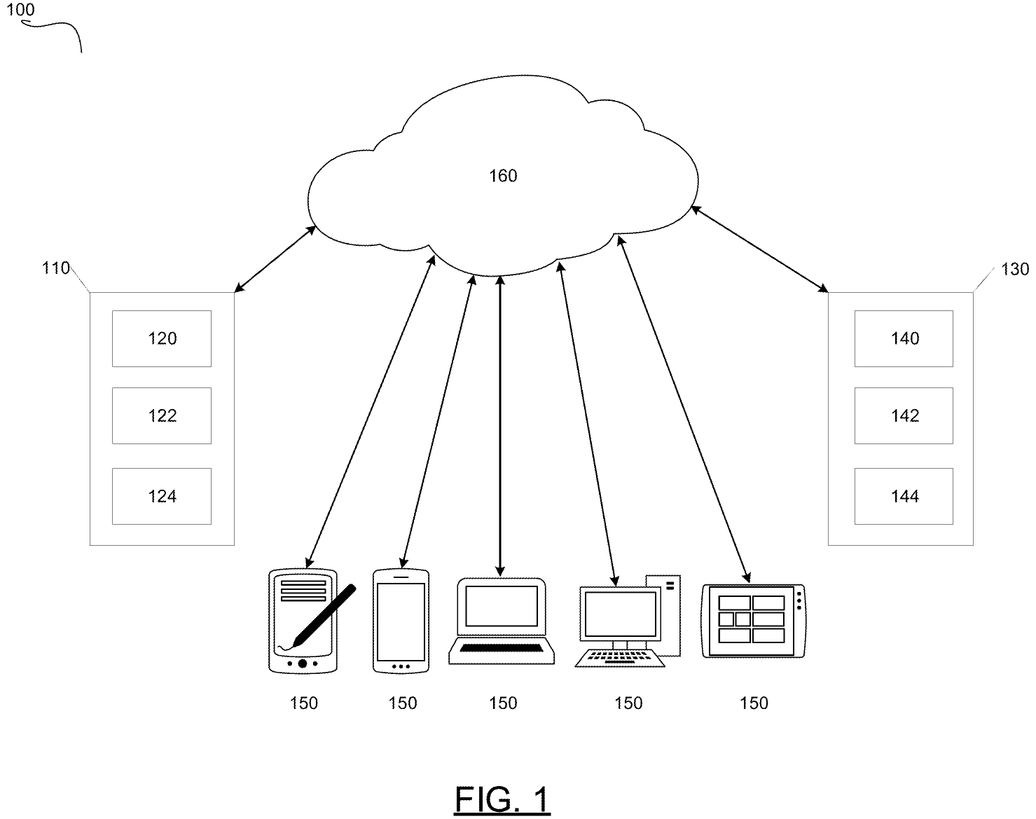

FIG. 1 is a block diagram of a system 100 for performing a multi-party search, according to embodiments of the present disclosure. System 100 includes a first party computing system 110, a second party computing system 130, computing devices 150 and network 160. Systems 110 and 130, as well as computing devices 150, are connected in bi-directional communication with network 160. Network 160 permits each of the systems and computing devices to communicate with one another to transmit and receive the information necessary to deliver a requested search.

First party computing system 110 can include any number of processors, memories, servers, databases, routers, gateways, interfaces, emulators, relays and/or other devices appropriate to return search results to second party computing system 130. The constituent components of first party computing system 110 can be connected or interconnected in a variety of configurations. Individual devices may communicate with one another via a wired connection or wirelessly, using various communication protocols as would be recognizable to one of skill in the relevant art.

More specifically, first party computing system 110 includes an input/output (I/O) interface 120, a search engine 122 and a database 124. Input/output interface 120 permits first party computing system 110 to communicate with second party computing system 130 and other devices as appropriate. Input/output interface 120 does so through various communications protocols useful for transmitting or receiving commands, information, or files consistent with embodiments of the application.

Search engine 122 is in communication with I/O interface 120 in order to receive search queries and additional information associated with those queries. As an example, search engine 122 can receive a query from second party computing system 130 via I/O interface 120, requesting an automobile search according to a specified rule set. Search engine 122 can then execute a search of database 124 based on the rules in the rule set to which engine 122 has access (i.e., the rules available to the first party).

The rules accessible by search engine 122 can be related to attributes within records or values of fields in the record set. As an example, a rule may relate to an information tag the search should either include or exclude while locating search results. In the case of an automobile search, the information tag could relate to a particular make, model, or auto dealer. For values of fields in the record set, the rules set may set minimums or maximums, such as a maximum vehicle price or mileage, as opposed to a minimum model year (e.g., 2015 so that only vehicles 2015 or later are searched). By employing the rules accessible by the search engine 122, subsets of records may be eliminated from the searching process. In embodiments, search engine 122 may be configured to remove one or more branches of a tree structure from the set of records to be queried. Rule engine 122 may also be configured to return a certain range of results, e.g., between 100 and 1000 results.

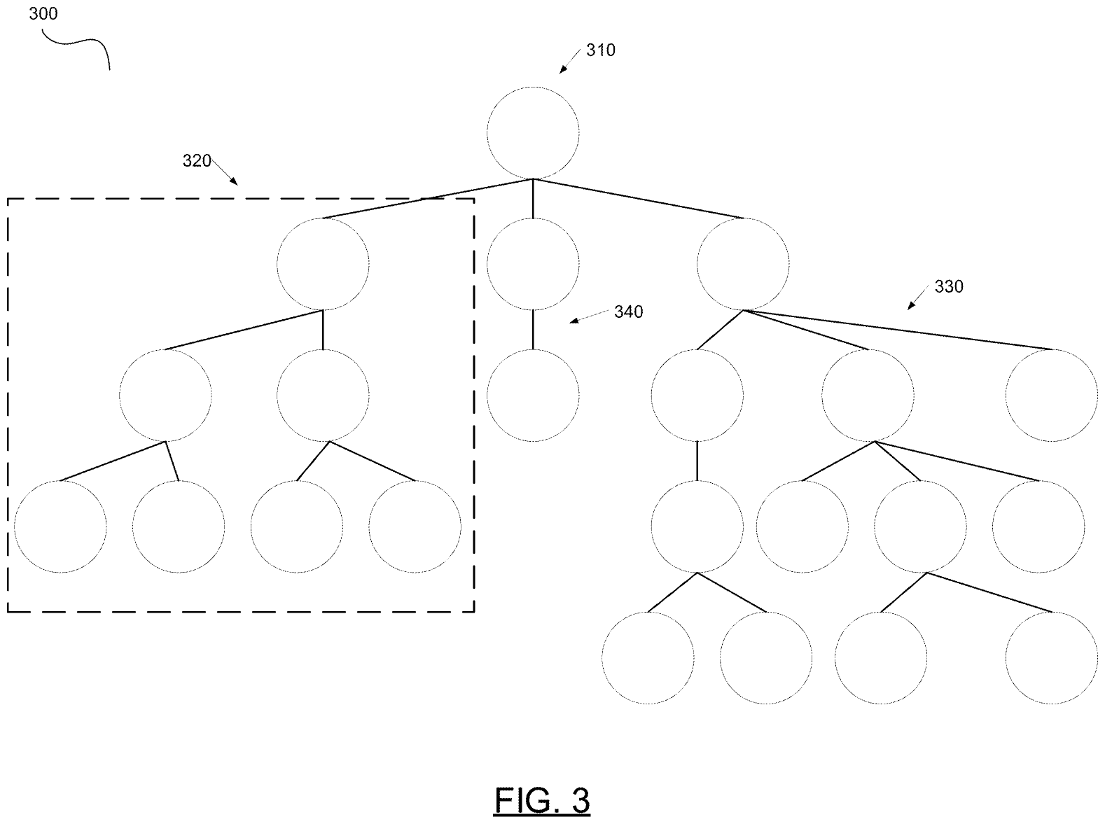

Database 124 contains all of the records available for search engine 122 to search, such as a collection of stored records pertaining to for-sale automobiles. Database 124 can store information in a variety of ways—one example being a data tree structure (shown in FIG. 3 and described below). Database 124 can be implemented as a wholly contained unit within computing system 110, or can be implemented in a distributed manner (e.g., through cloud storage). As further described above and below, search engine 122 can execute a search of a portion of the records stored in database 124.

Second party computing system 130 can include any number of processors, memories, servers, databases, routers, gateways, interfaces, emulators, relays and other devices as necessary to request search results from first party computing system 110 and return them to computing devices 150. The constituent components of second party computing system 130 can also be connected or interconnected in a variety of configurations. Individual devices may communicate with one another via a wired connection or wirelessly, using various communication protocols as would be recognizable to one of skill in the relevant art.

Second party computing system 130 includes an input/output interface 140, a rule engine 142, and a search interface 144. Input/output interface 140 enables second party computing system 130 to communicate with first party computing system 110, computing devices 150, and others as appropriate. Likewise, input/output interface 140 does so through various communications protocols useful for transmitting or receiving commands, information, or files consistent with embodiments of the application.

Rule engine 142 is in communication with I/O interface 140 in order to send search queries, receive search results, and any additional information associated with second party computing system 130. Rule engine 142 performs the dual function of maintaining the proprietary rules of the second party, which will not be transmitted to the first party, along with maintaining the rules which may be transmitted externally to improve search performance. The proprietary rules maintained by rule engine 142 may be any computational rules necessary for decisioning, such as calculations necessary to authorize a credit decision. The rules that may be transmitted externally can relate to any outward facing information or values, such as limits, rates, or descriptive tags for searching databases having relevant records.

As an example, rule engine 142 can send a query from second party computing system 130 via I/O interface 140. The request can be sent to the first party computing system 110 for an automobile search according to a specified rule set. Part of that request will include the portion of the rules that the second party can share, such as information tags or values for eliminating certain records. Based on this request sent by second party computing system 130 and containing the external facing rules that rule engine 142 has shared, search engine 122 can then execute a search of database 124 at first party computing system 110. The search is narrowed based on the rules in the rule set to which engine 122 has access (e.g., only vehicles having a model year of 2012 or later).

Search interface 144 permits entry and processing of details relevant to the search in order to construct the data set used by the first party to complete the search. This can be information provided by an applicant, such as users of computing devices 150, or information supplied by the second party directly at computing system 130. Search interface 144 enables both the information associated with the accessible portion of a rule set to be gathered, as well as the portion of the rule set that is only accessible by the second party. For example, search interface 144 can enable the entry of applicant details such as location, vehicle preferences, income, or other credit decisioning information in order to perform a pre-qualified vehicle search.

Computing devices 150 can be any standard computing device enabling the search and browsing of search results as provided by systems 110 and 130. Examples include smartphones, laptops, tablets, personal computers, and the like. Computing devices 150 are in bi-directional communication with second party computing system 130 to initiate and execute searches for records of interest. For example, the records of interest may be new or used automobiles available for purchase and searchable based on communications between systems 110 and 130. Computing devices 150 can provide information to system 130 in order to pre-qualify a vehicle purchase, such as the information noted above with respect to search interface 144 (e.g., location, vehicle information, income, etc.). Alternatively, some or all information to complete the search may be entered through computing system 130, allowing computing devices 150 to merely receive the search results once generated. One of skill in the relevant art will appreciate the variety of ways the information can be entered/gathered as well as received/displayed.

Turning to an example of system 100 in use, a data set for querying a set of automobile records in database 124 can be received at a computing system 110 for a vehicle listing service. The data set is received from a computing device 150 by way of a computing system 130. The data set is a pre-qualified vehicle application constructed based on a set of rules established by rule engine 142, where at least a first portion of the set of rules resides at computing system 130 is inaccessible to computing system 110, and a second portion of the rule set is accessible at computing system 110. In this example, the second portion of the set of rules sent by computing system 130 includes information tags requesting search results based on a location (vehicles within a 100-mile radius of a zip code) with a maximum listed price of $22,000.

Continuing with the example, a first subset of the set of records to be queried is eliminated by search engine 122 based on the location and price information sent by rule engine 142. In other words, all records outside of the location and above $22,000, are eliminated from the search. A second subset of the set of records in database 124, that is a remainder of the records when the first subset has been eliminated by search engine 122, can be searched by search engine 122 to provide a set of search results to computing system 130. Once completed, search engine 122 transmits at least a portion of the set of search results to computing system 130 by way of the I/O interfaces 120 and 140.

Search engine 122 may be further configured to sort the set of search results based at least in part on the second portion of the set of rules accessible at computing system 110, i.e., the location and price information. In this example, a number of results falling within a pre-determined range of 100 to 1000 results can be stipulated by search engine 122 and rule engine 142. In the example case, the second portion of the rule set can result in 750 records being searched. Thus, search engine 122 may be configured to transmit all 750 records in the remaining set of records to computing system 130, based on the remaining records falling below 1000 total search results. Once transmitted to computing system 130, a computing device 150 can access the results.

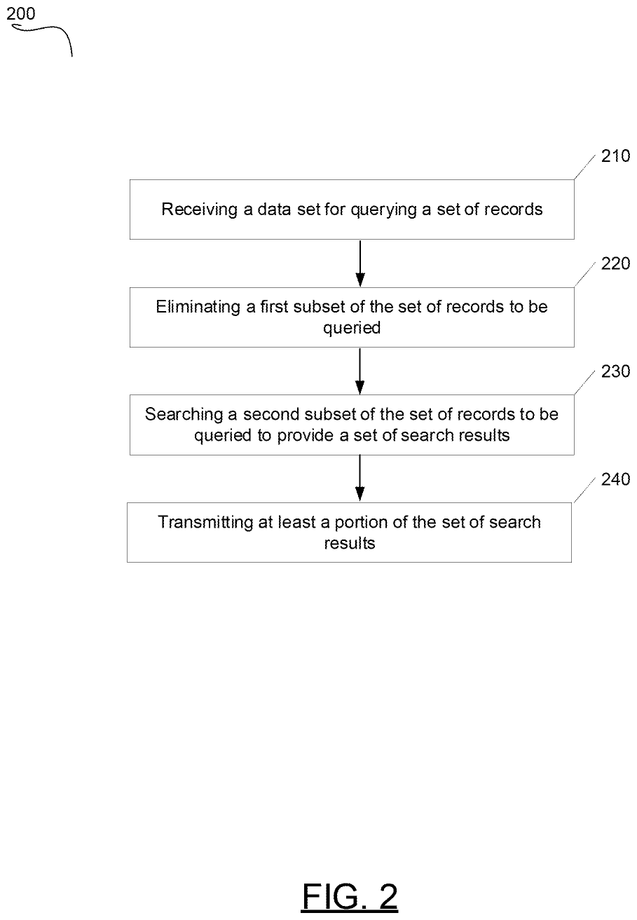

FIG. 2 is a flowchart representing a method 200 of providing search results, according to embodiments of the present disclosure. Method 200 involves first and second parties, which can be a listing service and lender as discussed above and below. The search results can be provided by the second party, while avoiding disclosing certain sensitive information to the first party, such as complex credit decisioning rules.

At a step 210, a data set for querying a set of records is received at a computing device of a first party. The data set is received from a client device associated with a second party. As an example, the first party can be an automobile listing service receiving a data set related to an auto search received from a lender (e.g., a bank, a credit union, or other auto finance provider).

The data set received at step 210 is constructed based on a set of rules established by the second party. At least a first portion of the set of rules is inaccessible to the first party, whereas a second portion of the set of rules is accessible to the first party. The second portion of the set of rules includes at least one or more information tags associated with the set of records or one or more threshold values related to corresponding value fields in the set of records. As one example, the rule set may have several information tags for which the search is to exclude results (such as excluding all makes from high-end sports car manufacturers).

A first subset of the set of records to be queried is eliminated at the computing device of the first party at a step 220. The first subset is eliminated based on either at least one information tag from among the one or more information tags associated with the set of records or at least one threshold value related to corresponding value fields in the set of records. As noted above, examples of these eliminated records could be all high-end sports car manufacturers and/or all vehicles over $75,000 in listed price.

At a step 230, a second subset of the set of records to be queried is searched at the computing device of the first party. The second subset of records is a remainder of the set of records when the first subset has been eliminated. The search is performed to provide a set of search results. At least a portion of the set of search results is transmitted from the computing device of the first party to the second party at a step 240. For example, the search results are transmitted to a lender to complete the search or further process the results against the lender's own confidential processing.

Eliminating the first subset of a set of records at step 220 can include removing (i.e., pruning) one or more branches of a tree structure from the set of records to be queried. This process will be described in further detail with respect to FIG. 3 below. As will be apparent to one of skill in the relevant art, the level and effect of those branches will vary significantly depending on the amount of records the pruning eliminates.

Transmitting at least a portion of the set of search results at step 240 can include sorting the set of search results based at least in part on the accessible rules or the information contained in those rules. For example, if there is a maximum vehicle value used in the received rules, the results may be sorted based on price from lowest to highest (or highest to lowest). If more than one tag or value is included, sorting can be prioritized accordingly. Other rules and sorting based on those rules are contemplated within the scope of this disclosure.

The transmitting of at least a portion of the set of search results at step 240 also may result in all of the search results not being sent to the second party, such as a lender. Rather, a number of results falling within a pre-determined range may be returned to the second party so as to provide enough results for variety, but not too many as to overwhelm the computational systems of the second party. As an example, the search may return a minimum of 100 results and maximum of 1000 results. Other ranges, such as 50 to 500, 50 to 1000 and 100 to 2000 results are examples of suitable search result counts.

Transmitting at least a portion of the set of search results to the second party may include transmitting all records in the remaining set of records. This may occur when a number of records in the remaining set of records to be searched, as a result of the eliminating step, is below a minimum results value. For example, the range of acceptable results may be between 100 and 2000 results. If the eliminating step results in 1400 records being available, then all 1400 may be transmitted.

As described above and below, the data set for querying a set of records includes receiving a data set constructed based on a set of credit rules established by a second party such as a lender. The received data set for querying a set of products can include one or more of “book” value (i.e., the fair value of the vehicle according to a rating service), purchase price, taxable title license amount, annual percentage rate of loan, loan term, monthly payment value, Vehicle Identification Number, dealer identifier, dealer name, latitude, longitude, city, state, zip code, make, model, vehicle year, stock number, trim style, body style, exterior color, interior color, vehicle use condition (e.g., new, used, certified preowned), drive type (e.g., four wheel drive, front wheel drive, rear wheel drive), engine configuration (e.g., number of cylinders, cylinder alignment), engine capacity (e.g., cubic liters, cubic centimeters), engine power (e.g., estimated horsepower), transmission type (i.e., manual or automatic), estimated city fuel consumption (i.e., “city mileage”), estimated highway fuel consumption (i.e., “highway mileage”), and fuel type (e.g., gas, diesel, electric, hybrid, flexible).

To give a full example from start to finish, a bank/lender may pre-qualify a potential buyer based on credit rules known only to the bank. After performing that pre-qualification process, the lender may send a search query with certain types of vehicles excluded because they do not lend against those vehicles (e.g., model years before 2010) as well as end results of the pre-qualification (e.g., a vehicle price limit). That search is received at the car listing service at a step 210.

The car listing service can eliminate the records based on the second portion of the rules at step 220, and perform the search at step 230, with all models before 2010 and under the price limit searched. Based on the elimination of other records, the search is executed more quickly than if the entire set of records is queried. The listing service can quickly return the 2000 results closest to the lending limit with newest model years as a result of the search at step 240, providing the search in acceptable time frames from a user experience standpoint.

FIG. 3 is a simplified diagram of a data structure 300 for carrying out a search, according to embodiments of the present disclosure. Data structure 300 is a tree data structure used to store data in a hierarchical manner. Data structure has a root node 310, a first branch 320, a second branch 330, and a third branch 340. Data structure 300 can be used to store data, such as that described above stored in database 124.

Root node 310 is a parent node having three branches (320, 330, 340) of nodes with various children, grandchildren, etc. The three child nodes may be any differentiating aspect of the records to be stored in the data structure. In returning to the examples above of a database of automobiles, the child nodes may represent different makes of vehicles. Thus, records of three different manufacturers' automobiles are stored in the three branches flowing from root node 310.

One of the child nodes of root node 310 is shown as part of first branch 320. First branch 320 is shown surrounded by dashed lines, because the branch can be pruned from the search based on an information tag or value for all of the nodes in that branch. Returning to the example of an automotive database, it may be that the party providing the search of the database does not sell or lend for the make stored in first branch 320. While this aspect of the lenders credit decisioning process need not be disclosed to the listing service, the end effect of the rule may be sent in the form of an exclusion tag. The information tag of make may thus be used to eliminate at least a subset of records to be searched and simplify the query process.

Second branch 330 and third branch 340 thus remain in the second subset of records to search. In the auto example, these may all be records pertaining to car makes for which the lender does provide financing. As an alternative example, additional branches of data structure 300 may be pruned based on other information or values stored in the structure (e.g., individual models of vehicles, model years, or vehicle price, among others). Thus, a portion of second branch 330 may alternatively be removed from the set of records prior to conducting the search to optimize the query.

One of skill in the relevant art will note that the data structure depicted in FIG. 3 is greatly simplified. In implementation, data structure 300 can have hundreds, thousands or even millions of records/nodes. Thus, the number of nodes and branches can be varied as appropriate based on various storage parameters. The number of branches or nodes that can be eliminated from the search will also vary based on the information tags or threshold values that are passed to the first party as the accessible part of the rules set. While a tree structure is depicted in the application, other data structures that allow for similar operations to take place are also consistent with this disclosure.

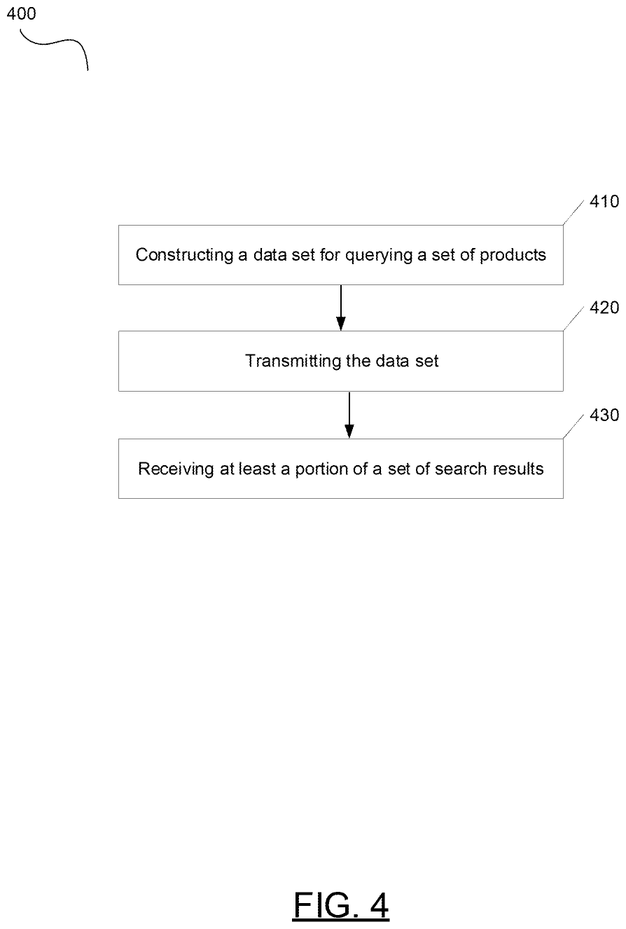

FIG. 4 is a flowchart representing a method 400 of receiving search results, according to embodiments of the present disclosure. Method 400 represents receiving the results in the manner that a second party listed throughout the figures and examples above, would receive them. Thus, one component of the method 400 is the manner and format in which information is shared with the first party.

At a step 410, a data set for querying a set of records is constructed by a computing device of a second party. The data set is constructed based on a set of rules established by the second party. At least a first portion of the set of rules is inaccessible to the first party, whereas a second portion of the set of rules is accessible to the first party. The second portion of the set of rules includes one or more information tags associated with the set of records or one or more threshold values related to corresponding value fields in the set of records.

At a step 420, the data set for querying a set of records is transmitted to a computing device of a first party from a client device associated with a second party. The second portion of the set of rules accessible by the first party is configured to enable the first party to query a subset of records within a larger set of records based on at least one information tag from among the one or more information tags associated with the set of records or at least one threshold value related to corresponding value fields in the set of records

At least a portion of a set of search results are received at a step 430. The search results are received at the client device associated with the second party from the computing device of the first party. Receiving the set of search results at step 430 can include receiving a sorted set of search results based at least in part on the accessible rules or the information contained in those rules. For example, the results can be sorted based on price from lowest to highest (or highest to lowest) if there is a maximum vehicle value used in the received rules. Other tags or values may be used to sort the search results.

Receiving at least a portion of the set of search results at the second party may include receiving all records in the remaining set of records. This may occur when a number of records in the remaining set of records to be searched, as a result of the eliminating step, is below a minimum results value. For example, the range of acceptable results can be between 100 and 2000 results. If the eliminating step results in 1400 records being available, then all 1400 may be transmitted.

As described above and below, the data set for querying a set of records includes receiving a data set constructed based on a set of credit rules established by a second party such as a lender. The transmitted data set for querying a set of products can include one or more of an annual percentage rate (APR) value, a purchase price value, a term length, a monthly payment value, an automobile dealer identifier, a postal code, a geographical identifier, an automobile model identifier, an automobile make identifier, a model year value, or a vehicle mileage value.

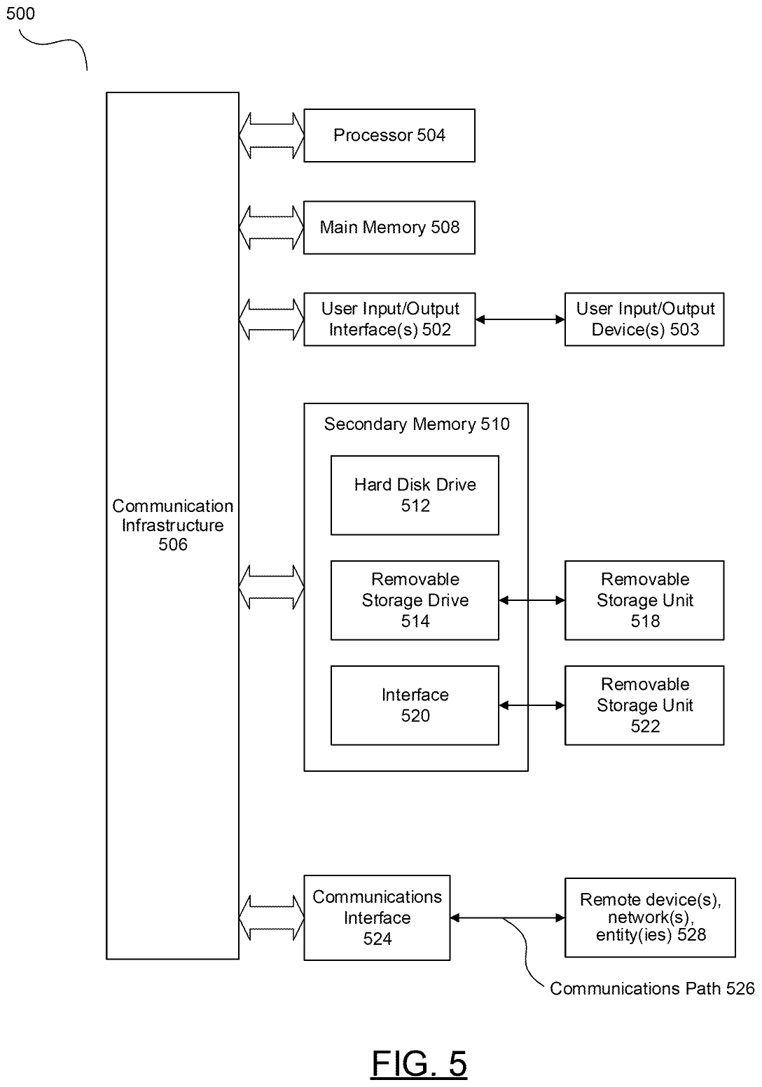

FIG. 5 depicts an example computer system useful for implementing various embodiments. Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 406 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data. Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/ any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not the Abstract section, is intended to be used to interpret the claims. The Abstract section may set forth one or more but not all exemplary embodiments of the present application as contemplated by the inventor(s), and thus, are not intended to limit the present application and the appended claims in any way.

The present application has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the application that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present application should not be limited by any of the above-described exemplary embodiments, but should be defined only in accordance with the following claims and their equivalents.

What is claimed is:

1. A method of providing search results, the method comprising:
receiving, at a computing device of a first party and from a client device associated with a second party, a data set for querying a set of records, wherein the data set is constructed based on a set of rules established by the second party, wherein at least a first portion of the set of rules is inaccessible to the first party, and wherein a second portion of the set of rules is accessible to the first party, the second portion of the set of rules including i) one or more information tags associated with the set of records or ii) one or more threshold values related to corresponding value fields in the set of records;
eliminating, at the computing device of the first party, a first subset of the set of records to be queried based on i) at least one information tag from among the one or more information tags associated with the set of records or ii) at least one threshold value related to corresponding value fields in the set of records;
searching, at the computing device of the first party, a second subset of the set of records to be queried to provide a set of search results, wherein the second subset of records is a remainder of the set of records when the first subset has been eliminated; and
transmitting, from the computing device of the first party to the second party, at least a portion of the set of search results.

2. The method of claim 1, wherein eliminating the first subset of a set of records comprises removing one or more branches of a tree structure from the set of records to be queried.

3. The method of claim 2, wherein transmitting the at least a portion of the set of search results to the second party comprises transmitting a number of results falling within a pre-determined range.

4. The method of claim 3, wherein transmitting the at least a portion of the set of search results to the second party comprises transmitting all records in the remaining set of records responsive to a number of records in the remaining set of records being below a minimum results value as a result of the eliminating step.

5. The method of claim 1, wherein receiving the data set for querying a set of records comprises receiving the data set constructed based on a set of credit rules established by the second party.

6. The method of claim 1, wherein transmitting the at least a portion of the set of search results to the second party comprises sorting the set of search results based at least in part on the second portion of the set of rules accessible by the first party.

7. The method of claim 1, wherein receiving the data set for querying a set of records comprises receiving one or more fields of data associated with an automobile purchase.

8. The method of claim 7, wherein receiving the data set for querying a set of products comprises receiving one or more of book value, purchase price, taxable title license amount, annual percentage rate of loan, loan term, monthly payment value, Vehicle Identification Number, dealer identifier, dealer name, latitude, longitude, city, state, zip code, make, model, vehicle year, stock number, trim style, body style, exterior color, interior color, vehicle use condition, drive type, engine configuration, engine capacity, engine power, transmission type, estimated city fuel consumption, estimated highway fuel consumption, and fuel type.

9. A system providing search results from a first party, the system comprising:
a memory; and
a processor in communication with the memory, configured to:
receive, at a computing device of a first party and from a client device associated with a second party, a data set for querying a set of records, wherein the data set is constructed based on a set of rules established by the second party, wherein at least a first portion of the set of rules is inaccessible to the first party, and wherein a second portion of the set of rules is accessible to the first party, the second portion of the set of rules including i) one or more information tags associated with the set of records or ii) one or more threshold values related to corresponding value fields in the set of records;
eliminate, at the computing device of the first party, a first subset of the set of records to be queried based on i) at least one information tag from among the one or more information tags associated with the set of records or ii) at least one threshold value related to corresponding value fields in the set of records;
search, at the computing device of the first party, a second subset of the set of records to be queried to provide a set of search results, wherein the second subset of records is a remainder of the set of records when the first subset has been eliminated; and
transmit at least a portion of the set of search results to the second party.

10. The system of claim 9 wherein the processor is further configured to remove one or more branches of a tree structure from the set of records to be queried.

11. The system of claim 10, wherein the processor is further configured to transmit a number of results falling within a pre-determined range.

12. The system of claim 11, wherein the processor is further configured to transmit all records in the remaining set of records responsive to a number of records in the remaining set of records being below a minimum results value as a result of the eliminating step.

13. The system of claim 9, wherein the processor is further configured to receive the data set constructed based on a set of credit rules established by the second party.

14. The system of claim 9, wherein the processor is further configured to sort the set of search results based at least in part on the second portion of the set of rules accessible by the first party.

15. The system of claim 9, wherein the processor is further configured to receive one or more fields of data associated with an automobile purchase.

16. The system of claim 9, wherein the processor is further configured to receive one or more of a book value, purchase price, taxable title license amount, annual percentage rate of loan, loan term, monthly payment value, Vehicle Identification Number, dealer identifier, dealer name, latitude, longitude, city, state, zip code, make, model, vehicle year, stock number, trim style, body style, exterior color, interior color, vehicle use condition, drive type, engine configuration, engine capacity, engine power, transmission type, estimated city fuel consumption, estimated highway fuel consumption, and fuel type.

17. A method of receiving search results, the method comprising:
constructing, at a computing device associated with a second party, a data set for querying a set of records based on a set of rules established by the second party, wherein at least a first portion of the set of rules is inaccessible to a first party, and wherein a second portion of the set of rules is accessible to the first party, the second portion of the set of rules including i) one or more information tags associated with the set of records or ii) one or more threshold values related to corresponding value fields in the set of records;
transmitting, to a computing device of the first party from a client device associated with a second party, the data set for querying the set of records, wherein the second portion of the set of rules accessible by the first party is configured to enable the first party to query a subset of records within a larger set of records based on i) at least one information tag from among the one or more information tags associated with the set of records or ii) at least one threshold value related to corresponding value fields in the set of records; and
receiving, at the client device associated with the second party and from the computing device of the first party, at least a portion of a set of search results.

18. The method of claim 17, wherein receiving the at least a portion of the set of search results by the second party comprises receiving a number of results falling within a pre-determined range.

19. The method of claim 17 further comprising:
constructing the data set based on a set of credit rules established by the second party;
transmitting one or more fields of data associated with an automobile purchase.

20. The method of claim 19, wherein transmitting the data set for querying a set of products comprises transmitting one or more of a book value, purchase price, taxable title license amount, annual percentage rate of loan, loan term, monthly payment value, Vehicle Identification Number, dealer identifier, dealer name, latitude, longitude, city, state, zip code, make, model, vehicle year, stock number, trim style, body style, exterior color, interior color, vehicle use condition, drive type, engine configuration, engine capacity, engine power, transmission type, estimated city fuel consumption, estimated highway fuel consumption, and fuel type.
